(19) United States
(12) Patent Application Publication
(10) Pub. No.: US 2008/0115131 A1
(43) Pub. Date: May 15, 2008

(54) Express task manager system and method

(76) Inventors: Jeff Kelsey, Burien, WA (US); Kris Barker, Seattle, WA (US); Kathy Boscole, Renton, WA (US)

Correspondence Address: DLA PIPER US LLP, 2000 UNIVERSITY AVENUE, E. PALO ALTO, CA, 94303-2248, US

(21) Appl. No.: 11/600,530

(22) Filed: Nov. 15, 2006

(51) Int. Cl. G06F 9/46

(52) U.S. Cl. 718/100

(57) ABSTRACT

An express task manager system and method are provided that uses a data store of process/files associated with an application information so that the express task manager is able to provide additional information about a process/file listed in the task manager.

### FIELD OF THE INVENTION

A computer system application manager unit is provided.

### BACKGROUND OF THE INVENTION

When a personal computer (PC) user launches desktop applications on a Microsoft Windows®—based computer (a machine), the user launches one or more application files. Each application file includes one or more executable files (known as “exe files”) that are loaded into the memory of the personal computer. For example, the well known Microsoft Word application includes a winword.exe file and a well known solitaire application may includes a sol.exe file. A computer user can see a graphical list of the exe files (hereafter “processes”) running on a PC at any time using a Windows® utility called the Task Manager. The names listed in the Task Manager of these processes are not intuitive and therefore the user can not easily determine the application(s) that are running at any particular time. Thus, when there is a problem on a machine, for example the machine is running slowly or some type of Trojan horse or virus has invaded the machine, it is difficult, if not impossible for the user to determine from the list of processes listed in the Task Manager which applications are currently running on the machine. For example, Symantec® Antivirus, a common desktop virus blocking application, uses a process with the name “rtvscan.exe.” When a user looks at the Task Manager to see which processes are running, it is impossible to quickly determine if rtvscan.exe is from a legitimate application, or represents a harmful Trojan horse on the machine. This problem is even more elevated in large company environments where a “help desk” individual may be troubleshooting a problem on a user's machine so that quickly determining what processes are running can be very challenging.

Currently, users will typically attempt to take a process name (such as “rtvscan.exe”) and input this name into a search engine such as Google. The user will then attempt to determine the application that is associated with the particular process/file name. Sometimes, through painstaking research, the user may be able to determine the application associated with the process/file. The shortcoming of a Google search is that the user will often find conflicting information on the specifics about an application and whether or not the application is harmful. In addition, the search is not a definitive source of information on these processes.

Others have attempted to build a utility application that can, when queried with a process/file name, return the process name in response to the query. The limitation with these utility applications is that they do not have an extensive and dynamic database of application scans that they can use to accurately identify these processes so they have limited value.

### BRIEF DESCRIPTION OF THE DRAWINGS

FIG. 1 is a diagram illustrating a client server architecture implementation of an express task manager system;

FIG. 2 is a diagram illustrating an exemplary embodiment of the express task manager system and its method;

FIGS. 3-10 illustrate an example of the data schema for the express software identification database (ESID);

FIG. 11 illustrates an example of an ESID query using SQL code;

FIG. 12 illustrates an example of the user interface of the express task manager with a pop-up window showing the details of an application from the ESID;

FIG. 13 illustrates an example of the user interface of the express task manager showing the hardware information for the computer;

FIGS. 14 and 15 illustrate an example of the user interface of the express task manager showing the processes grouped after querying the ESID;

FIG. 16 illustrates an example of the user interface of the express task manager for connecting to a remote machine to query the running applications using the express task manager system.

### DETAILED DESCRIPTION OF AN EMBODIMENT

The invention is particularly applicable to a software-based, web-based, client/server architecture express task manager system and method and it is in this context that the invention will be described. It will be appreciated, however, that the system and method has greater utility since: 1) the system and method can be implemented in software (as is shown in the exemplary embodiment), software and hardware or hardware; 2) the system can be implemented using a plurality of different architectures, such as the client/server architecture described below which is the illustrative embodiment, a stand-alone computer model in which the ESID database and express task manager are co-located on the same computer, a peer-to-peer architecture in which each peer computer may store a portion of or copies of the ESID database, an application service provider architecture in which the service of the identification of the files/processes in the task manager is communicated to a computer or a hosted architecture; and 3) the system and method may include other elements not described below that are within the scope of the system and method. To illustrate the system, a client-server architecture of the express task manager system is described below.

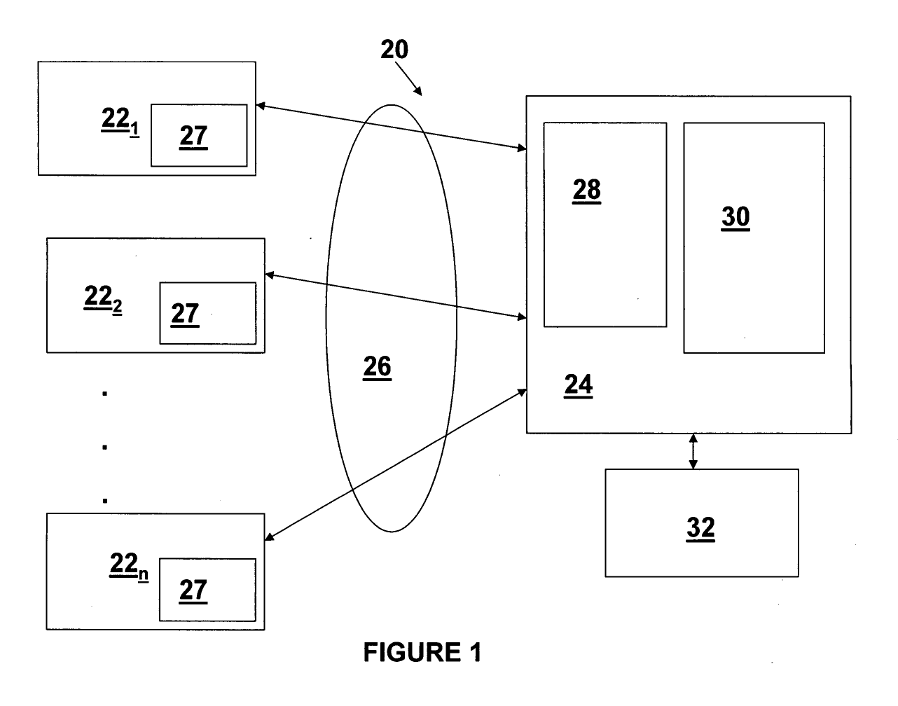

FIG. 1 is a diagram illustrating a client server architecture implementation of an express task manager system 20. The system 20 may include one or more first computing devices 22, such as first computing devices 22₁, 22₂, 22ₙ, that can establish a session with a second computing device 24 over a network 26 and then communicate information over the network. In an exemplary embodiment of the system, a client server architecture is used in which each first computing device may have a client express task manager unit 27 that implements a portion of the express task manager system functionality as described below. In one exemplary embodiment, the unit 27 has a plurality of lines of computer code that are executed by a processing unit of the first computing device in order to perform the functions and operations described in more detail below. The client express task manager unit, however, may be implemented in other manners in other architectures as described above and these other implementations of the client express task manager unit are within the scope of the system. Each first computing device may be a processing unit based device, such as one that uses a Pentium processor) that has sufficient memory, a display unit and connectivity to establish a communications session with and communicate with second computing device wherein the first computing device may include a personal computer, a laptop computer, a desktop computer, a Windows CE-based portable computing device such as a PocketPC, a mobile phone, a wireless email device and the like.

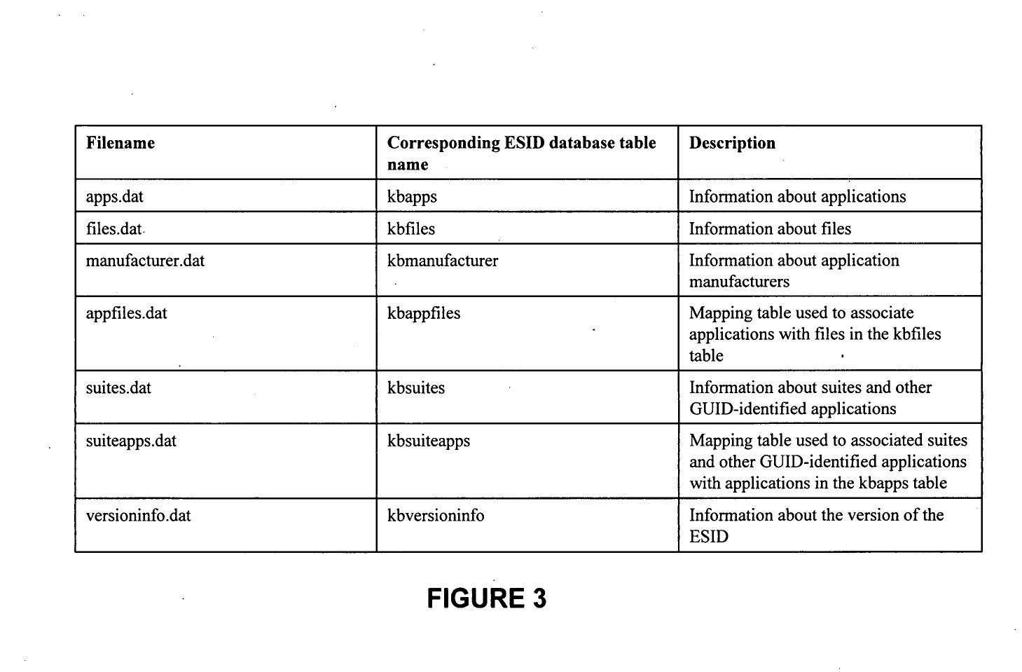

The second computing device 24 may be a processing unit based device, such as one that uses a Pentium processor) that has sufficient memory and connectivity to establish communications sessions with and communicate with one or more first computing devices, such as a server computer in the exemplary client/server architecture. In the exemplary embodiment shown in FIG. 1, the second computing device 24 may include a web server application 28 that establishes the session with each first computing devices and exchanges data and information with the first computing devices and an express manager server unit 30 (that may include a database manager unit) that performs various operations described below and interfaces with a data store 32, that may be a database in the exemplary embodiment, which stores the information and data used for the express task manager system. An example of the data schema of the data store is described below with references to FIGS. 3-10.

The network 26 may be any communications or computer network that permits the one or more first computing devices to communicate with the second computing device using a protocol, such as the internet, the World Wide Web, a local area network, a wide area network, a digital cellular network and the like. In the exemplary embodiment, the network may be the internet.

In the exemplary client/server model shown in FIG. 1, the unit 27 is located on the first computing devices and the unit 30 and the data store 32 are associated with the second computing device. However, the units and data store may all be co-located on a single computing device in a stand-alone model. Alternatively, the data store 32 may be spread across multiple computing devices when a peer-to-peer model is used. In addition, with an ASP model or hosted model, the first computing devices may use a typical browser application to interact with the express task manager system and will not include the unit 27.

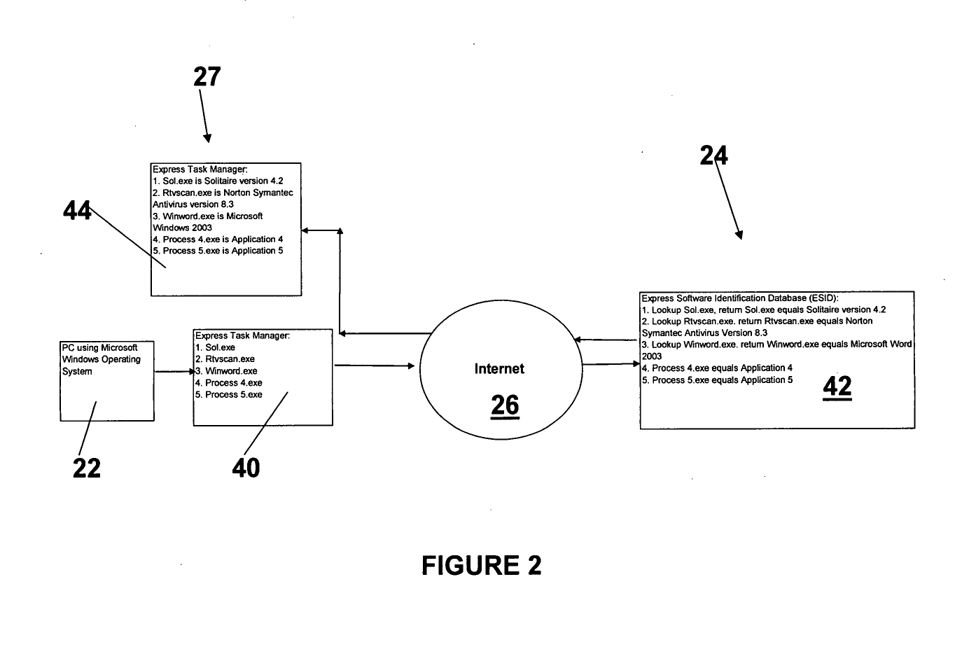

FIG. 2 is a diagram illustrating an exemplary embodiment of the express task manager system 20 and its method. In this embodiment, the data store 32 may be a proprietary database of executable names and associated applications. The express software identification database (hereafter “ESID”) has been collected over a 9 year period and contains more than 90,000 executable signatures. The details of an example of the ESID is described below with respect to FIGS. 3-10. In an express task manager method shown in FIG. 2, the user may launch the express task manager unit and the express task manager unit 27 (that may be software application with a plurality of lines of computer code executing on the first computing device 22 that is a personal computer running the Windows operating system) may gather a list of the processes currently running on the personal computer (40), such as for the sol.exe, Rtvscan.exe, Winword.exe, Process 4.exe and the Process 5.exe processes shown in FIG. 2. For example, the unit may use a well known Windows Management Instrumentation (WMI) to query the operating system for the following variables: the running processes; a ProcessID for each running process; an execution path for each running process; the hardware information for the personal computer; and the drives associated with the personal computer. The unit may also use the WMI to query the file system of the personal computer for the file size for each running process.

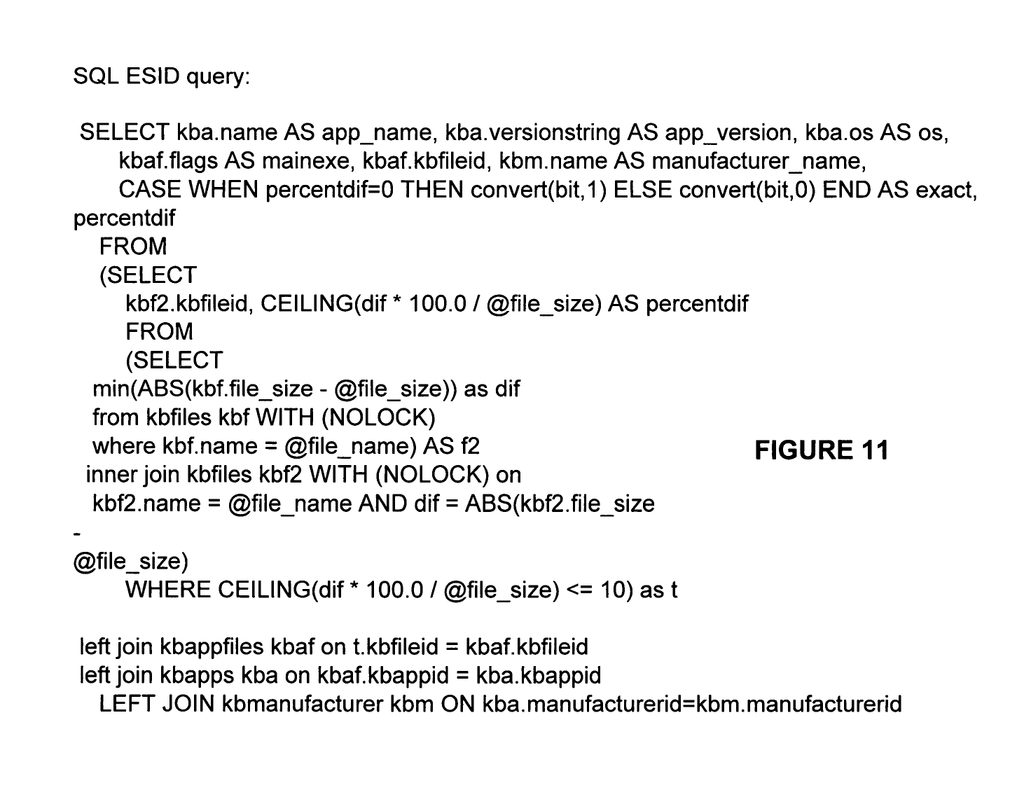

The unit 27 may then communicate the names of the processes and file sizes to the second computing device over the network 26 and query the data store 32 associated with the data store. The second computing device 24 then performs a comparison of the list of processes and file sizes against the data in the data store (42). As shown in FIG. 2, the method looks up the processes provided by the express task manager and determines the associated application (and potentially the version) for each process as shown in FIG. 2. The comparison may be performed, for example, by the second computing device running a web service using asp.net and a current version of the Express Software Identification Database (ESID) running on a well known SQL Server wherein the web service uses the well known SQL language to query the ESID. An example of the SQL query to the ESID for a particular implementation is shown in FIG. 11. A specific implementation of the comparison may determine, if a process name is the same and the file size is within 10% of the same exe file signature in the ESID, a close match is returned and, if the process name and file size are the same as the exe file signature stored in the ESID, an “exact match” is returned.

The second computing device may then provide the list of associated application names, versions and identification to the user, optionally including whether or not each process/file is a primary executable for an application or a support file. The unit 27 then displays the list of running processes to the user (44) wherein users can either click on a process to return the application or “hover” to find the ESID information about each process/file.

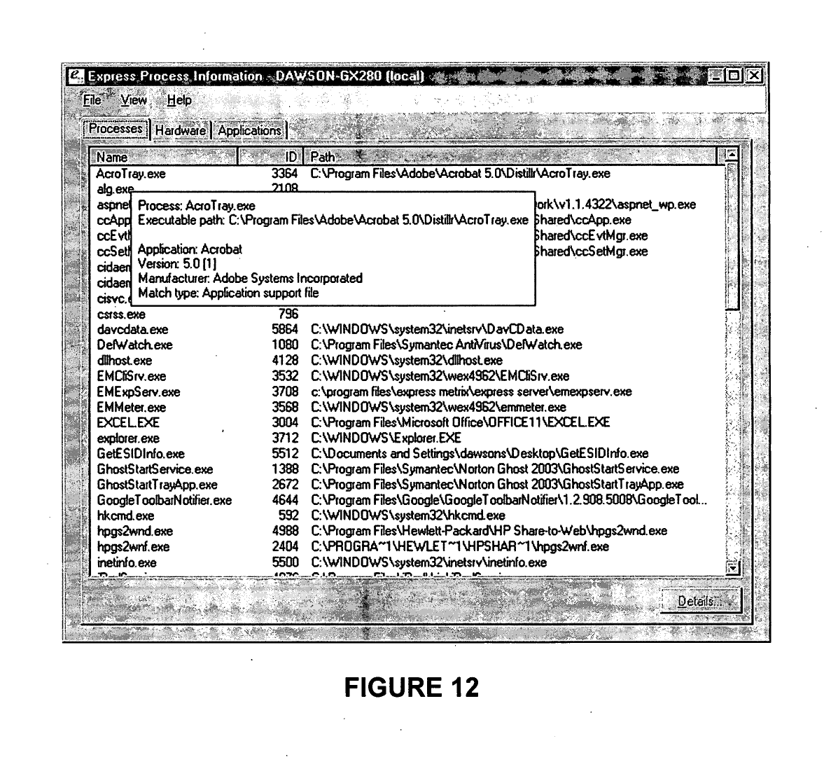

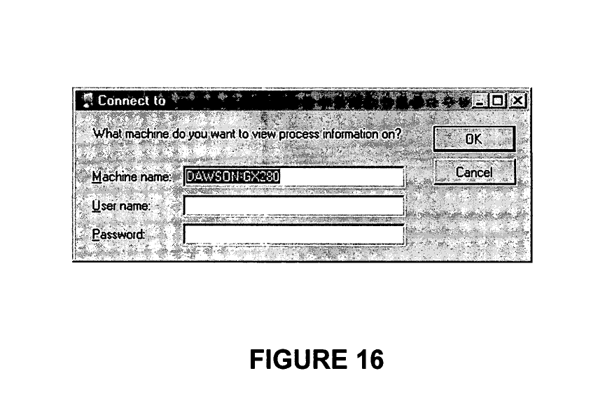

The system may also provide the user with the ability to access a remote machine and check its processes/files with an example of the user interface for the remote login shown in FIG. 16. In a specific implementation, the ability is provided since the unit 27 uses WMI to connect to a remote machine using user input machine name and credentials as shown in FIG. 16. The same type of display of the processes and the information from the ESID (similar to that shown in FIG. 12) is shown except that the processes/files and the associated ESID information is for the processes/files on the remote machine/computing device. The express task manager method allows a user to be able to clearly see what applications are running on their machines at any time. The method also provides the user with an indication of which executables/processes are legitimate and which executables/processes are suspect which saves significant effort in solving computer problems related to performance, data loss, intrusion, etc. Now, a specific implementation of the ESID and its data schema will be described with reference to FIGS. 3-10 although the system is not limited to the data schema shown in FIGS. 3-10.

In a commercial implementation of the ESID (not yet released to the public), the ESID is provided in a ZIP format file which contains 7 .dat files, each of which contains the data corresponding to a single table within the ESID itself. The .DAT files are in a format similar to CSV (comma separated value) as defined in http://www.ietf.org/rfc/rfc4180.txt with the following exceptions:
There is no header line in any file. (Section 2.3 of the above referenced document specifies that the header line is optional.)
A vertical bar (“|”) character, ASCII 124 (0x7C), is used instead of a comma to separate the fields as described in Section 2.4. This character was chosen to eliminate the problem of the separator character appearing in the data. The vertical bar character will never appear as part of an actual data item; it will only appear as the separator character.
No data will be quoted. If a quote character is encountered, it is to be treated as a part of the data itself.

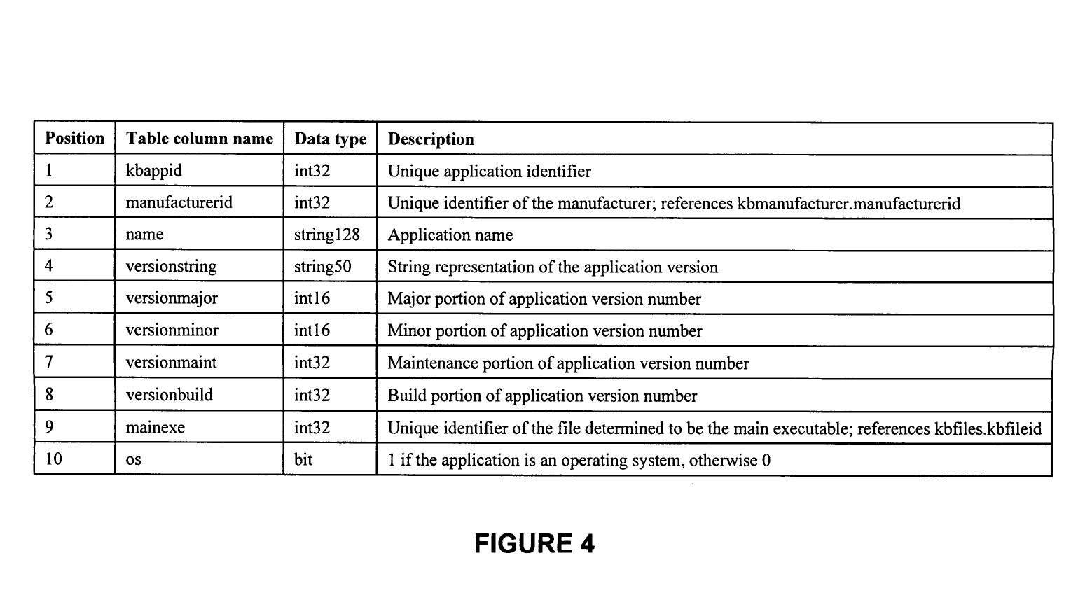

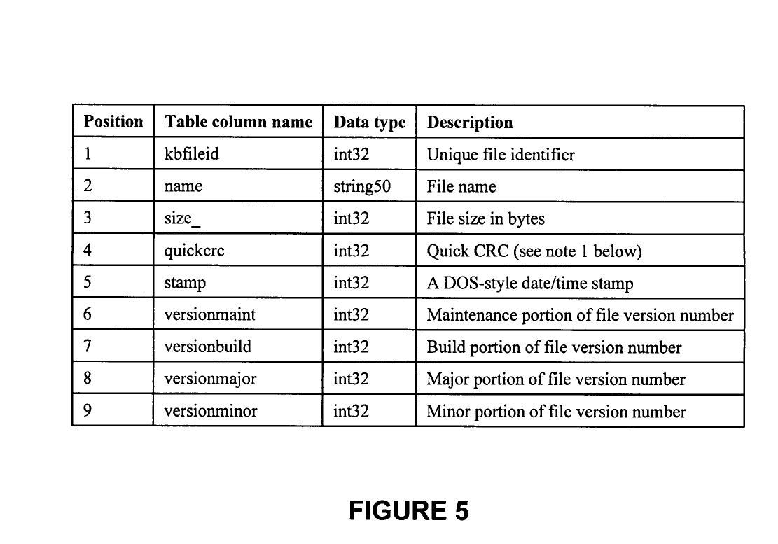

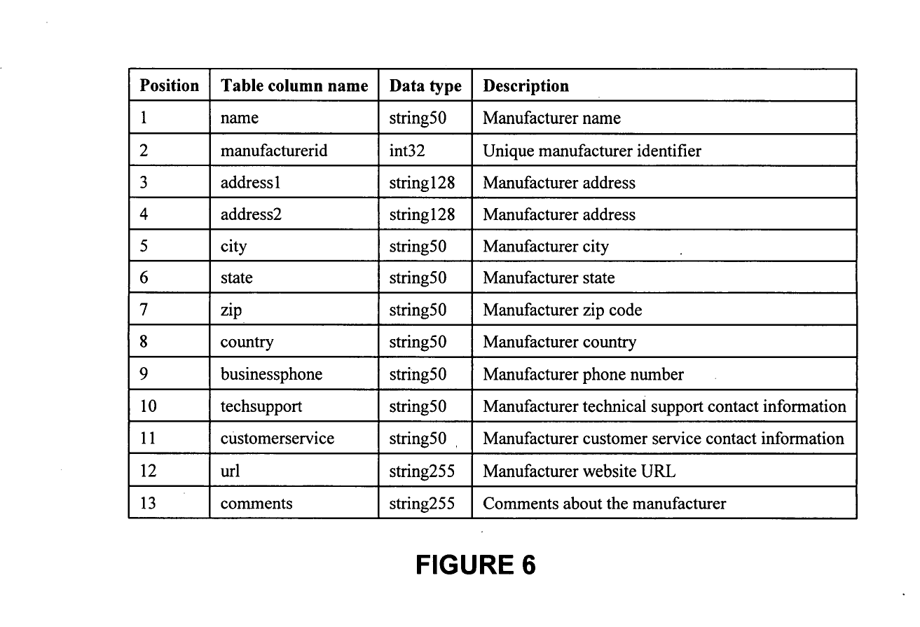

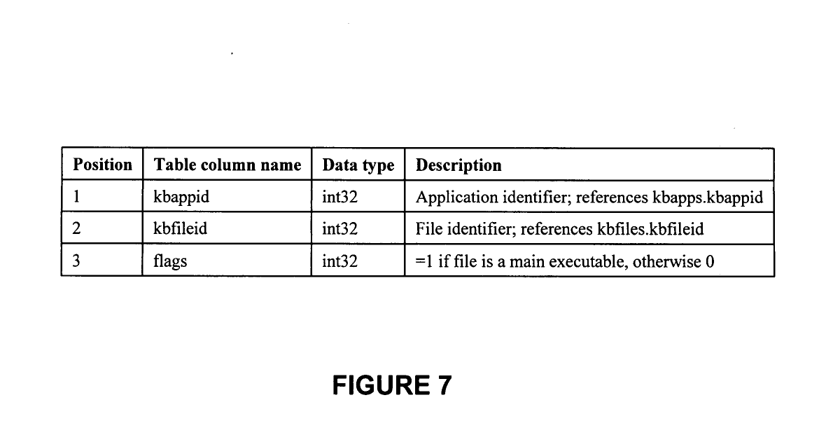

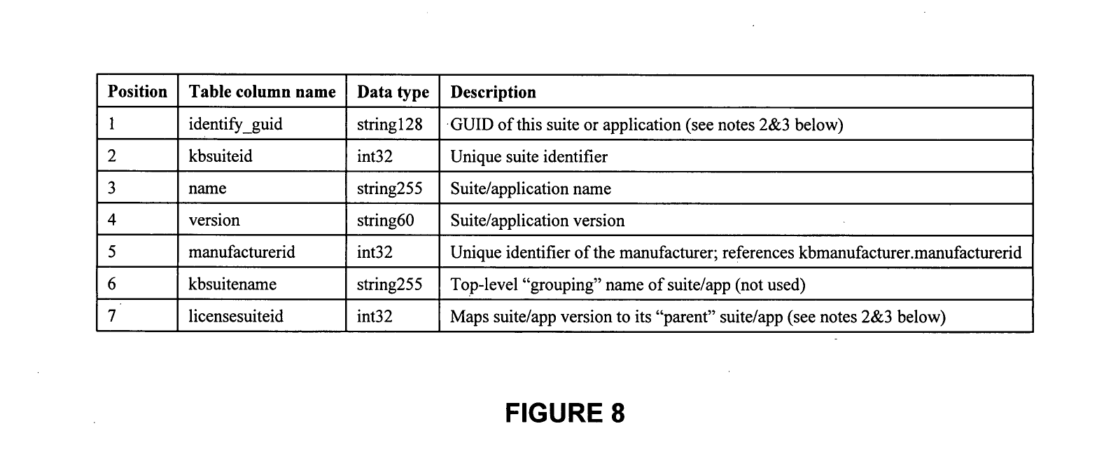

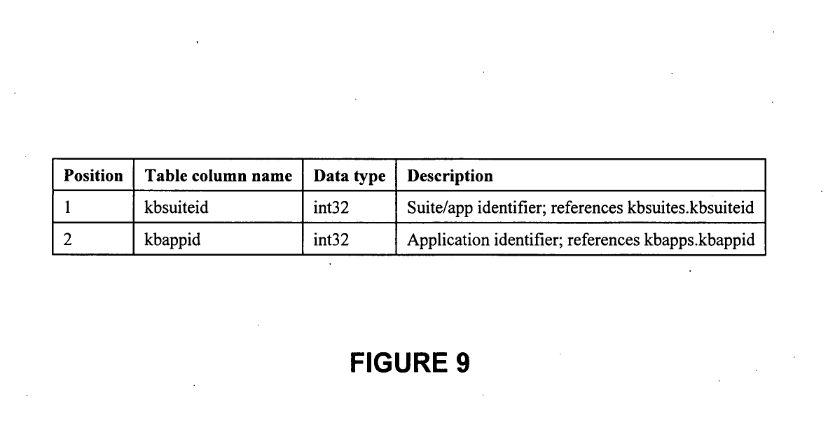

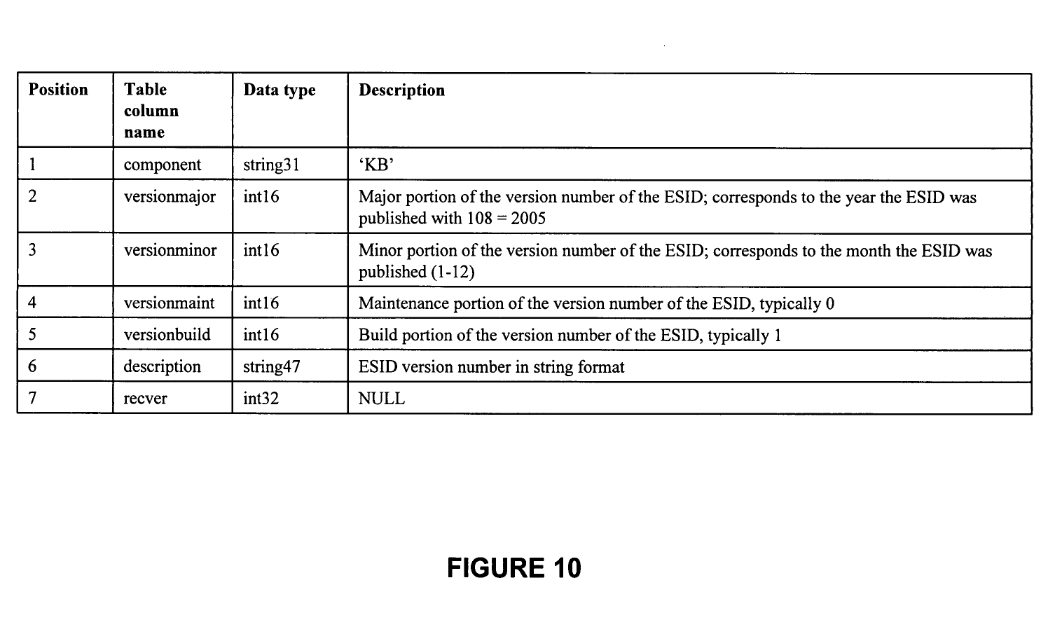

As shown in FIG. 3, the ESID may include an applications table (from an apps.dat file) that contains information about each application (described in more detail below with reference to FIG. 4), a files table (from an files.dat file) that contains information about each file (described in more detail below with reference to FIG. 5), a manufacturer table containing information about each application manufacturer (described in more detail below with reference to FIG. 6), a mapping table (from an appfiles.dat file) that is a mapping table used to associate each application with each process/file in the files table (described in more detail below with reference to FIG. 7), a suites table (from an suites.dat file) that contains information about application suites and other GUID-identified applications (described in more detail below with reference to FIG. 8), a suites applications table (from an suiteapps.dat file) which is a mapping table used to associate suites and other GUID-identified applications with applications in the applications table (described in more detail below with reference to FIG. 9) and a version table (from an versioninfo.dat file) that contains information about any version(s) of the ESID (described in more detail below with reference to FIG. 10). In the exemplary tables shown in FIGS. 4-10, the following short names are used for the data types contained in the tables: int32—signed 32-bit integer; int16—signed 16-bit integer; string<n>—variable length string with max size of <n> and bit—bit value (0 or 1). For purposes of establishing copying of the ESID once publicly released, the ESID data may contain markers (dummy data) that permits copying of the ESID without authorization to be more easily detected.

FIG. 4 illustrates more details of the applications table (kbapps) which can be generated from the apps.dat data file and shows each field of the applications table. Similarly, FIGS. 5-10 show more details of the files table (FIG. 5), the manufacturer table (FIG. 6), the mapping table (FIG. 7) to associate the applications with the files, the suites table (FIG. 8), the mapping table (FIG. 9) to associate the suites and GUID-identified applications with the applications in the applications table and the table (FIG. 10) containing the version of the ESID, respectively.

Each of ESID table files contains a “quick-CRC”, that is, a CRC value based on the first 1024 (1K) bytes of the file wherein the CRC is calculated using the standard CRC-32 algorithm as defined in ISO 3309. The kbsuites and kbsuiteapps tables are used to store information used to associate applications (as defined in the kbapps tables) with GUIDs (Global Universal Identifiers) to better handle situations where a file signature alone is not sufficient to completely identify the application. This GUID-based identification is used in two specific situations:

a. Suite identification—the GUID identifies a set of applications that are licensed as a suite (such as Microsoft Office).

b. Application identification—the GUID can also be used in situations where the application's main executable is present in more than one product configuration, such as a Standard and Professional version. The GUID can then be used to distinguish one from the other.

The kbsuites table contains information about applications/suites both from a version-level perspective and a licensing-level perspective:
a. Each unique suite or application is specified by a “license level” entry. License level entries are used to “group” different versions of the same suite or application. License level entries have the following characteristics:
   1. The value in the identity_guid is not actually a GUID, rather, it is a string representation of the entry's unique ID (kbsuiteid field).
   2. The value in the version field is always NULL.
   3. The value in the licensesuiteid field is always equal to the value in the kbsuiteid field.
b. Each version of the application or suite has the following characteristics:
   1. The identity_guid value is normally a string in GUID format. (The primary exception to this are the entries for the Windows Operating System where the “GUID” is really a value collected from WMI.)
   2. The value in the licensesuiteid field refers to the license level entry used to group this version with others of the same suite or application.

As noted in note 3 above, the identity_guid field of any Windows Operating System entry in the kbsuites table is a string created using WMI (Windows Management Instrumentation) properties. Specifically, the value is created by concatenating the Win32_OperatingSystem.Caption and Win32_OperatingSystem.CSDVersion properties, separated by a space character if the CSDVersion property is not blank. Now, examples of the user interface of the express task manager system is described in more detail.

FIG. 12 illustrates an example of the user interface of the express task manager with a pop-up window showing the details of an application from the ESID. In particular, the user interface of the express task manger shows the information typically associated with the well known task manager, but also permits the user to roll over an entry in the task manager, such as acrotray.exe in the example in FIG. 12, and the express task manager shows the information pulled from the data store (the ESID in the exemplary embodiment). In this example, that data includes the full name of the application, its version number, the manufacturer and the type of file (which is an application support file in this example). The additional information from the data store permits the user to more easily determine the application associated with the .exe file and whether or not it is a danger to the computer.

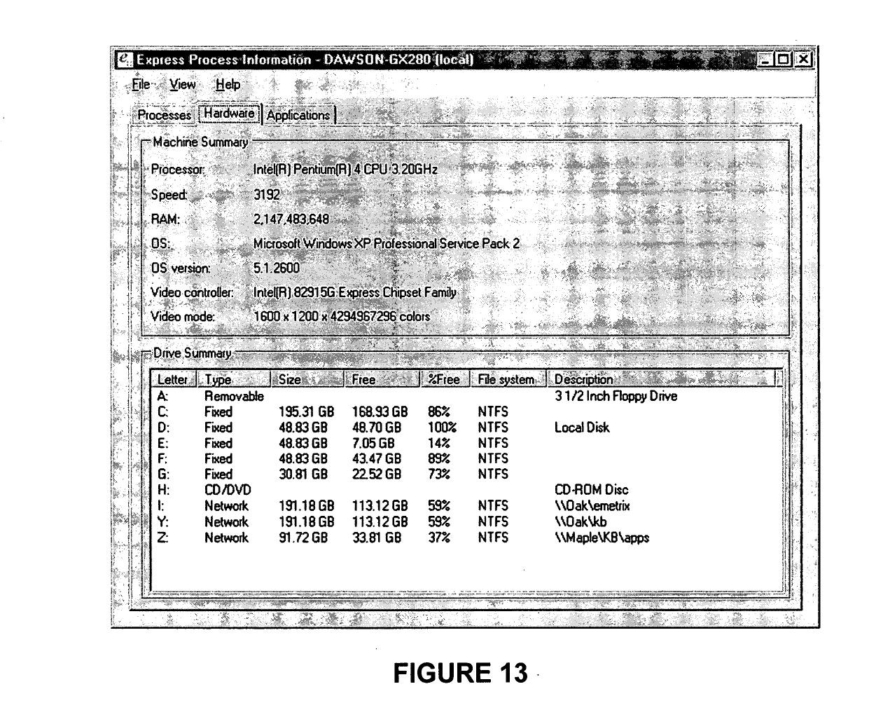

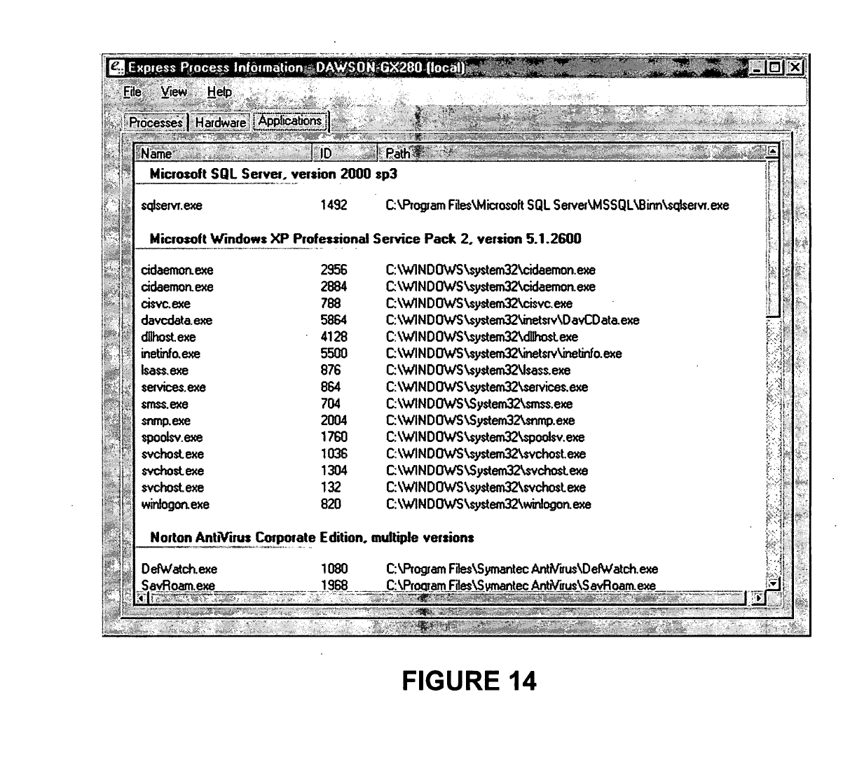

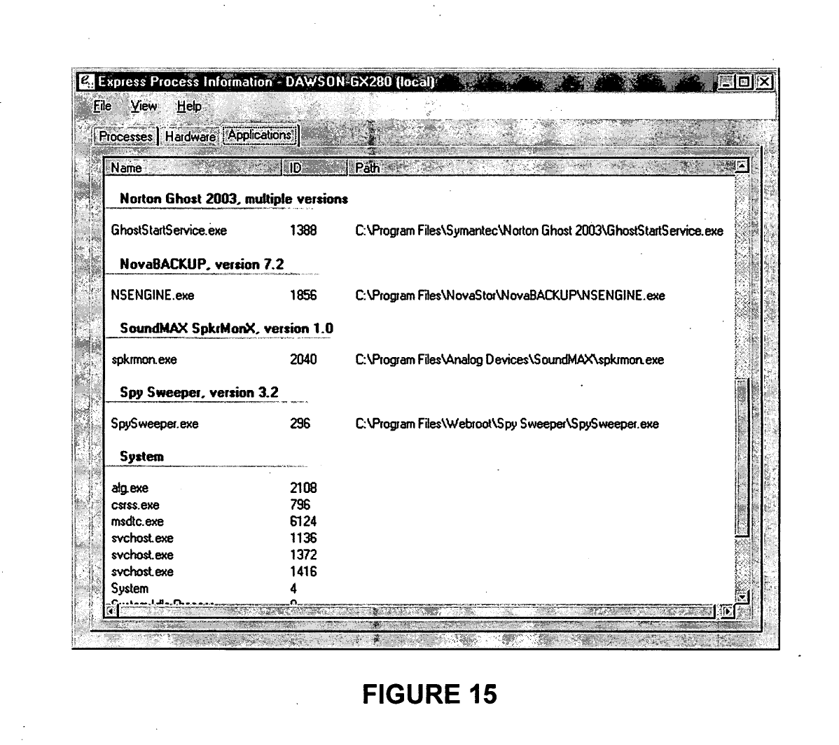

FIG. 13 illustrates an example of the user interface of the express task manager showing the hardware information for the computer which is also typically available using the well known task manager utility in Windows. FIGS. 14 and 15 illustrate an example of the user interface of the express task manager showing the processes grouped after querying the ESID wherein the processes/files are grouped based on the information/data extracted from the ESID. In this example, the SQL server processes/files, the Windows XP files/processes, etc. are grouped together so that a user can quickly determine which files/processes are associated with each suite/set of applications/application. Again, the user interface permits the user to quickly determine the application associated with each file/process.

While the foregoing has been with reference to a particular embodiment of the invention, it will be appreciated by those skilled in the art that changes in this embodiment may be made without departing from the principles and spirit of the invention, the scope of which is defined by the appended claims.

1. An express task manager system, comprising:
a computing device having a task manager unit that gathers a piece of information about a process currently being executed on a computing device on which the task manager unit resides;
a task manager server unit having a data store having a plurality of records wherein each record contains a particular process and a set of application information associated with particular process and wherein the task manager unit matches the piece of information about the process against the records in the data store and retrieves the set of application information associated with the particular process when the piece of information about the process matches a record for a particular process in the data store; and
a display unit that displays the set of application information associated with the process.

2. The system of claim 1, wherein the piece of information further comprises one or more of a name of the process and an execution path of the process.

3. The system of claim 2, wherein the set of application information further comprises an application name, a manufacturer of the application and a version of the application.

4. The system of claim 3, wherein the task manager unit gathers a piece of information about a plurality of processes currently being executed on the computing device, wherein the task manager server unit retrieves a plurality of sets of application information associated with particular processes when the piece of information about the processes match records for the particular processes in the data store, and wherein the display unit displays a list of plurality of processes organized based on the application associated with each process.

5. The system of claim 1, wherein the task manager unit gathers a piece of information about a process currently being executed on a second remote computing device.

6. The system of claim 1, wherein the task manager server unit resides on the computing device.

7. The system of claim 1, wherein the task manager server unit resides on a second computing device.

8. The system of claim 1 further comprising a first peer computing device and a second peer computing device connected to each other in a peer relationship and wherein a first portion of the data store resides on the first peer computing device and a second portion of the data store resides on the second peer computing device.

9. The system of claim 6, wherein the display unit displays a user interface of an express task manager generated by the task manager server unit.

10. The system of claim 6, wherein the computing device further comprises the display unit.

11. The system of claim 1, wherein the computing device further comprises a personal computer, a laptop computer, a desktop computer, a Windows CE-based portable computing device, a mobile phone or a wireless email device.

12. A process identification method, comprising:
gathering a piece of information about a process currently being executed on a computing device;
matching the piece of information about the process against a data store having a plurality of records wherein each record contains a particular process and a set of application information associated with particular process;
retrieving the set of application information associated with the particular process when the piece of information about the process matches a record for a particular process in the data store; and
displaying the set of application information associated with the process.

13. The method of claim 12, wherein the piece of information further comprises one or more of a name of the process and an execution path of the process.

14. The method of claim 13, wherein the set of application information further comprises an application name, a manufacturer of the application and a version of the application.

15. The method of claim 14, wherein gathering further comprises gathering a piece of information about a plurality of processes currently being executed on a computing device, wherein retrieving further comprises retrieving a plurality of sets of application information associated with particular processes when the piece of information about the processes match records for the particular processes in the data store, and wherein displaying the set of application information further comprises organizing the list of plurality of processes based on the application associated with each process.

16. The method of claim 12 further comprising gathering the piece of information about a process currently being executed on a remote computing device.
